(19) United States
(12) Patent Application Publication
(10) Pub. No.: US 2025/0272780 A1
(43) Pub. Date: Aug. 28, 2025

(54) System for Translation of Images Between Two Distinct Heterogenous Cameras and a Method Thereof

(71) Applicants: Robert Bosch GmbH, Stuttgart (DE); Bosch Global Software Technologies Private Limited, Bangalore (IN)

(72) Inventors: Amit Arvind Kale, Karnataka (IN); Koustav Mullick, Kolkata (IN); Michael Miksch, Renningen (DE); Prabhat Kumar, Athmalgola (IN)

(21) Appl. No.: 19/055,889

(22) Filed: Feb. 18, 2025

(30) Foreign Application Priority Data
Feb. 27, 2024 (IN) 2024 4101 4088

(51) Int. Cl. G06T 3/20; G06T 3/18; G06T 5/60

(52) U.S. Cl. CPC G06T 3/20; G06T 3/18; G06T 5/60; G06T 2207/20084

(57) ABSTRACT

A system for translation of images between two distinct heterogenous cameras and a method thereof is disclosed. The system includes a source camera, a target camera, two generative adversarial networks, a transformation prediction module and at least a warping module. The transformation prediction module is configured using the system and method to derive a transformation parameter. The transformation prediction module is optimized using a loss function comprising loss between a translated source image vis-à-vis a target image and a translated target image vis-à-vis a source image.

This application claims priority under 35 U.S.C. § 119 to patent application no. IN 2024 4101 4088, filed on Feb. 27, 2024 in India, the disclosure of which is incorporated herein by reference in its entirety.

The present disclosure relates to the field of image processing. In particular, disclosed herein is a system for translation of images between two distinct heterogenous cameras and a method thereof.

### BACKGROUND

Image classification, object detection, semantic segmentation or instance segmentation are all tasks of interest in computer vision. These tasks have their ultimate applications in many real-world applications ranging from assisted and automated driving scenarios to application on our mobile phones. The recent success of deep learning approaches for computer vision tasks has led to the need for large amounts of annotated image data. Consider a scenario where a manufacturer provides a camera-based product to different OEMs. The manufacturer has collected a lot of data via the camera (Source) used in the products and provides numerous services on top of the product to OEMs. All research and development are at a high level of maturity from a product standpoint. Now, say due to improvement in camera technology as well the requirement specified by various OEMs, the manufacturer needs to migrate to a new camera (Target) system which provides various improvements as compared to the previous camera system.

In the above scenario, the transition of the various system and methods to the new camera or target camera system can be a time taking process since the source camera holds huge amounts of image with annotated data. The annotations of the source camera need to be replicated for the target camera system for numerous types of captured images. The process of annotation of images is extremely expensive and time consuming, and perhaps the most expensive process in the development of any data-driven application of image processing. Image-to-image translation is a technique that translates a source image into a target image while preserving certain visual properties of the original image.

The state of the art in this area can be categorized into two types. First are Image to Image translation systems tries to take images from the source camera and translate the imaging characteristics such as contrast, color correction, brightness, etc., to the target camera, while keeping the semantics of the image same as the source. Second are task-aware domain adaptation systems, where the aim is to make a downstream task system adapt from the source camera inputs to function also on the target camera inputs. Furthermore, from a flow estimation point of view, the prior arts are limited to calculation of flow for single camera setup or homogenous camera setup.

However, none of the known approaches help in automatically transferring the annotations available from the source camera to the target camera captured images. It either needs to be done explicitly using some pre-trained networks to obtain pre-labels, or it goes through the same manual annotation process by human labelers. The present disclosure proposes to solve this problem through a unified and task-agnostic system that provides a robust and accurate translation of images between the source and target cameras and allows the transfer of semantics from the source camera to the target camera system. As a result, the system further allows for the quick transfer of multiple types of annotations from the source camera to the target camera and bypasses the need for annotation using external methods for the target camera system (like pre-label networks or human annotation).

### BRIEF DESCRIPTION OF THE DRAWINGS

An embodiment of the disclosure is described with reference to the following accompanying drawings:

FIG. 1 depicts a system (100) for translation of images between two distinct heterogenous cameras (S,T);

FIG. 2 illustrates method steps for translation of images between two distinct heterogenous cameras (S,T).

### DETAILED DESCRIPTION

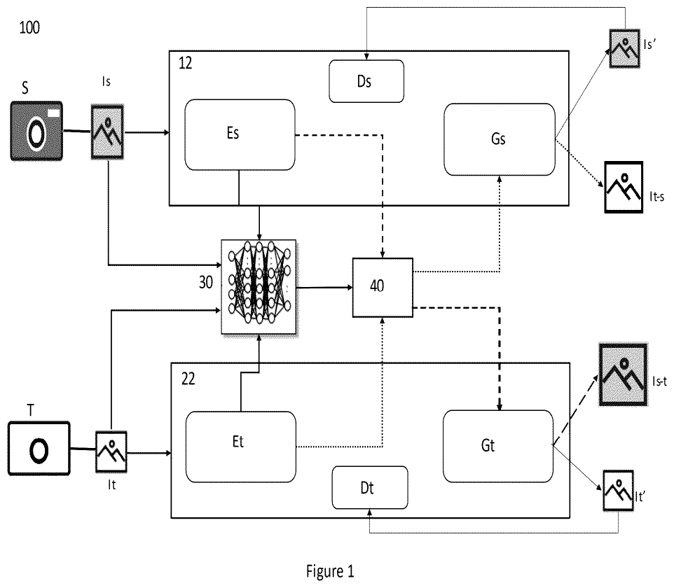

FIG. 1 depicts a system (100) for translation of images between two distinct heterogenous cameras (S,T). The system (100) comprises a source camera(S), a target camera (T), two generative adversarial networks (GAN) s, a transformation prediction module (30) and at least a warping module (40). The two cameras are distinct in terms of the lens characteristics and the semantics of the images captured. Both the camera S and T capture images simultaneously. The images captured are later synchronized, i.e., images Is from S are associated with images, It from T such that the difference in capture timestamp is kept below a predefined threshold (for example 9 ms):

|Timestamp(Is)−Timestamp(It)|<=9 ms (predefined threshold)

It should be noted for most of such image pairs (Is,It) the timestamp difference is rarely zero due to various factor which depends on the hardware characteristics of the two cameras, namely—Frame per Second(fps), capturing pipeline latency post-capture trigger, etc.

The source camera (S) capturing a source image is in communication with a first generative adversarial network (GAN). The first GAN (12) comprises a source encoder (Es), a source generator (Gs) and a discriminator. The target camera (T) capturing target images is in communication with a second generative adversarial network (GAN), the second GAN (22) comprising a target encoder (Et) and at least a target generator (Gt), characterized in that system (100).

The encoder-generator pair are tasked with learning latent representation of its respective cameras and generating an image from the 25 latent image respectively, i.e., for example Encoder Es convert the input image Is into its latent representation Zs such that, Zs=Es(Is) and then Gs decodes a Zs to reconstruct image Is'. Similarly for the second or the target camera (T) using Et and Gt with latent representation, input, and reconstruction as Zt, It, and It' respectively. The reconstruction objective acts as a supervision for learning camera-specific features. The respective discriminators ensure that encoders and generators are pitted against each other such that it maximizes the learning of the encoders and generators. To perform camera characteristics translation, we assume a shared latent representation learning approach for the two cameras. To enforce it, we perform weight sharing between encoders and generators. We tie up the weights of the final and initial layers of encoders (Es, Et) and generators (Gs and Gt).

Once latent representations are learned, it allows us to perform the interchanging of latent features from one encoder to a different generator. In principle, the encoders encode the semantics into the latent code, removing the camera-specific information and once it is passed into the generator it adds the camera-specific information on the semantics passed as input to it. We encode the semantics of the Is into Zs and when passed into the Generator (Gt), the target camera (T)-specific information is added onto the semantics specified by Zs to get Is-t as per the equation below:

Is−t=Gt(Zs)

Both learning of camera-specific features and shared latent space representation is aided by GAN's adversarial loss and Cyclic consistency loss. Hence, the source generator (Gs) is configured to generate a Translated Target Image. The target generator (Gt) is configured to generate a Translated Source Image.

The transformation prediction module (30) is configured to receive intermediate outputs of the source encoder(Es) and the target encoder (Et) along with source image and target image as input. The transformation prediction module (30) run an AI model. A person skilled in the art would be aware of the neural network types of AI model and the various types of neural architecture such as Convolutional Neural Networks, Recurrent Neural Networks, Transformers and the like. It must be understood that this disclosure is not specific to the type of model being executed. A person skilled in the art will also appreciate that the AI module may be implemented as a set of software instructions, combination of software and hardware or any combination of the same. For example, a neural network are specialized silicon chips, which incorporate AI technology and are used for machine learning. In an exemplary embodiment of the present disclosure, transformation prediction module (30) is a neural network trained to optimize the loss between the translated source image vis-à-vis target image and translated target image vis-à-vis source image. The transformation prediction module (30) therefore derives (using method step 200) a final transformation parameter that can be used to translate images between the two cameras.

The warping module (40) is in communication with the transformation prediction module (30. The output of the warping module (40) is fed to the source generator (Gs) and the target generator (Gt) conditioned with inputs Zt and Zs to the warping module respectively. The warping module (40) can either be a logic circuitry or a software programs that respond to and processes logical instructions to get a meaningful result. It may be implemented in the system (100) as one or more microprocessors, microcomputers, microcontrollers, digital signal processors, central processing units, state machines, logic circuitries, one or more microchips or integrated circuits interconnected using a parent board, hardwired logic, software stored by a memory device and executed by a microprocessor, firmware, an application specific integrated circuit (ASIC), and/or a field programmable gate array (FPGA), and/or any component that operates on signals based on operational instructions.

As used in this application, the terms “module,” “system,” “network,” are intended to refer to a computer-related entity or an entity related to, or that is part of, an operational apparatus with one or more specific functionalities, wherein such entities can be either hardware, a combination of hardware and software, software, or software in execution.

It should be understood at the outset that, although exemplary embodiments are illustrated in the figures and described below, the present disclosure should in no way be limited to the exemplary implementations and techniques illustrated in the drawings and described below.

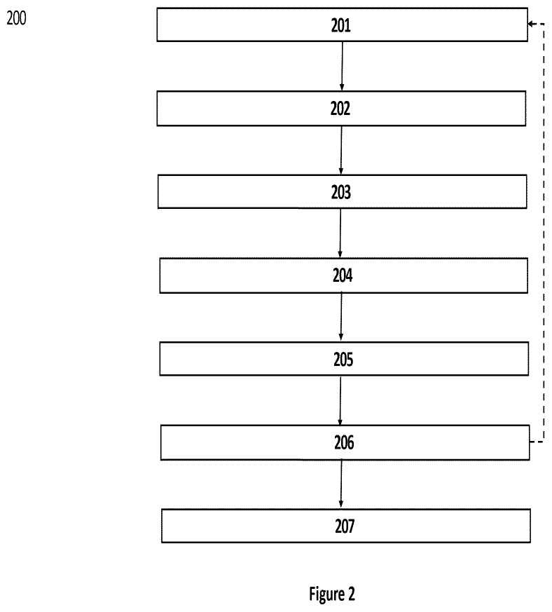

FIG. 2 illustrates method steps for translation of images between two distinct heterogenous cameras. The system (100) comprising the heterogenous cameras has been elucidated in accordance with FIG. 1. For the purposes of clarity, it is reiterated that system (100) comprises a source camera (S), a target camera (T), two generative adversarial networks (GAN)s, a transformation prediction module (30) and at least a warping module (40). The source camera (S) capturing source images is in communication with first generative adversarial network (GAN), the target camera (T) capturing target images in communication with second generative adversarial network (GAN).

Method step 201 comprises providing intermediate output of the source encoder (Es) and the target encoder (Et) along with source image and target image as input to a transformation prediction module (30). The source encoder (Es) and target encoder (Et) get source image and target image as input respectively from the source camera (S)s and target camera (T)s respectively. They extract some intermediate features from the image which is fed as input to the transformation prediction module (30).

The transformation prediction module (30) is based on optical flow-based semantic translation, where the optical flow aims to predict the movement of semantics from one image to another for each pixel in the source image to the target image. The output T i.e. the transformation parameter is of size [height (Is)=width (Is)=2] such that Ti,j=[u,v] represents the movement of pixel i,j in Is in x and y direction respectively and the new co-ordinates of i,j in It is given by m,n such that:

m=i+u

n=j+v

This transformation parameter is derived in the method step 206.

Method step 202 comprises executing a warping module (40) with outputs from the transformation prediction module (30), source encoder (Es) and at least the target encoder (Et). Method step 203 comprises feeding in Zt and Zs into warping module and the output acts as input to both the source generator (Gs) and the target generator (Gt) respectively. The warping module (40) is primarily a differentiable interpolation module. The warping module (40) takes in the feature map as input, repositions and interpolates the pixel features according to the transformation parameters provided by the Transformation prediction block. This transformation parameters are learnt by the transformation module when it is configured.

Method step 204 comprises running the source generator (Gs) and target generator (Gt) with to generate a translated target image and a translated source image respectively. Method step 205 comprises defining a loss function comprising loss between the translated source image vis-à-vis target image and translated target image vis-à-vis source image (L1−L2 ((Is−t), It)+L1−L2 ((It−s), Is)).

Method step 206 comprises optimizing the loss function to configure the transformation prediction module (30). In an exemplary embodiment of the present disclosure, the transformation prediction module (30) is a neural network. Optimizing the loss function comprises tuning the network parameters and hyperparameters of the neural network. The network enforces the learning of transformation parameter via the following optimization equation.

L1−L2 ((Is−t), It)+L1−L2 ((It−s), Is)

The equation enforces the Transformation prediction module (30) to learn transformation such that in translated images the pixel position is as close as possible, reducing the loss. Also, it should be noted that the weight of the forementioned loss in the total optimization equation gradually increases as the training progresses, allowing the system (100) to first adapt to the camera characteristics and later the semantic translation. Based on the above transformation prediction module (30) derives the transformation parameter “T”.

Method step 207 comprises running the configured transformation prediction module (30) to enable translation of images between the two distinct heterogenous cameras (S,T). Once configured the transformation prediction module (30) gives transformation parameters that can be used to easily convert a source image to a translated source image in respect of a target camera (T).

The basic idea here is to provide semantic translation via the transformation parameter. Camera translation in general translates properties such as Brightness, Contrast, Saturation etc. from one camera to another. Overall, the system (100) proposed tries to mimic both the post-capture-post-processing pipeline of its respective camera through its encoder-generator pair. Translation in such characteristics does not translate the change in the position of objects/semantics in the image, as these characteristics are introduced in the post-processing pipeline and are independent of the semantics captured by the camera. Through the semantic translation task, we aim to translate the camera lens-specific properties, mainly—field of view, distortion, etc. from the source camera(S) to the target.

A person skilled in the art will appreciate that while these method steps describes only a series of steps to accomplish the objectives, these methodologies may be implemented with customizations and modifications to the system (100).

This idea to develop a system (100) for translation of images between two distinct heterogenous cameras and a method thereof helps in the reuse of matured systems based on the source camera (S) and its data to expedite the development of the target camera (T) system immensely. This is very important in applications where data assists to increase the accuracy of the system. For example, a user switching from an iPhone camera to a Samsung camera can have all their data annotation (face recognition tags, location tags etc.) transferred automatically. Other realworld technical solution for the transformation prediction module could be in 3-D rendering. 3D video rendering such as SFMs (Structure from Motion) from images are often restricted by camera type, positioning. Using the proposed Cross camera flow or transformation prediction can reduce the dependency on camera type and positioning. Similarly in automotive industry, a car manufacturer deploying driving assistance cameras can upgrade cameras mounted on vehicle without worrying about exuberant data collection and system transfer costs.

It must be understood that the embodiments explained in the above detailed description are only illustrative and do not limit the scope of this disclosure. Any modification to the system (100) for translation of images between two distinct heterogenous cameras and a method thereof are envisaged and form a part of this disclosure. The scope of this disclosure is limited only by the claims.

What is claimed is:

1. A system for translation of images between two distinct heterogenous cameras, comprising:
a source camera configured to capture a source image in communication with a first generative adversarial network (first GAN), the first GAN comprising a source encoder and at least a source generator;
a target camera configured to capture target images in communication with a second generative adversarial network (second GAN), the second GAN comprising a target encoder and at least a target generator;
a transformation prediction module configured to receive intermediate outputs of the source encoder and the target encoder as input; and
a warping module in communication with the transformation prediction module, the output of the warping module being fed to the source generator and the target generator.

2. The system for translation of images between two distinct heterogenous cameras as claimed in claim 1, wherein the source generator is configured to generate a Translated Target Image.

3. The system for translation of images between two distinct heterogenous cameras as claimed in claim 1, wherein the target generator is configured to generate a Translated Source Image.

4. The system for translation of images between two distinct heterogenous cameras as claimed in claim 1, wherein the transformation prediction module is trained to optimize the loss between the translated source image vis-à-vis target image and translated target image vis-à-vis source image.

5. A method for translation of images between two distinct heterogenous cameras, wherein a source camera is configured to capture a source image in communication with a first generative adversarial network (first GAN), the first GAN comprising a source encoder and at least a source generator, and wherein a target camera is configured to capture target images in communication with a second generative adversarial network (second GAN), the second GAN comprising a target encoder and at least a target generator, the method comprising:
providing output of the source encoder and the target encoder along with source image and target image as input to a transformation prediction module;
executing a warping module with outputs from the transformation prediction module, source encoder and at least the target encoder;
feeding the output of the warping module as input to both the source generator and the target generator;
running the source generator and target generator to generate a translated target image and a translated source image respectively;
defining a loss function comprising loss between the translated source image vis-à-vis target image and translated target image vis-à-vis source image;
optimizing the loss function to configure the transformation prediction module; and
running the configured transformation prediction module to enable translation of images between the two distinct heterogenous cameras.

6. The method for translation of images between two distinct heterogenous cameras as claimed in claim 5, wherein the transformation prediction module is a neural network.

7. The method for translation of images between two distinct heterogenous cameras as claimed in claim 5, wherein optimizing the loss function comprises tuning the network parameters and hyperparameters of the neural network.

8. The method for translation of images between two distinct heterogenous cameras as claimed in claim 5, wherein the transformation prediction module is configured to derive a transformation parameter.
